(19) United States
(12) Patent Application Publication
(10) Pub. No.: US 2003/0127757 A1
(43) Pub. Date: Jul. 10, 2003

(54) Method and installation for injection moulding a plastic article

(76) Inventors: Ronaldus Johannes Cornelis Maria Kok, Eindhoven (NL); Michael Adrianus Theodorus Hompus, Helmond (NL); Marinus Franciscus Johannes Evers, Heeze (NL)

Correspondence Address: YOUNG & THOMPSON, 745 SOUTH 23RD STREET 2ND FLOOR, ARLINGTON, VA, 22202

(21) Appl. No.: 10/275,717

(22) PCT Filed: May 9, 2001
(86) PCT No.: PCT/NL01/00354

(51) Int. Cl. B29D 11/00; B29C 45/20

(52) U.S. Cl. 264/1.33; 264/2.2; 425/192 R; 425/589; 425/810

(57) ABSTRACT

A method for the injection moulding of a plastic article, such as a CD or DVD comprises the following steps: the provision of a mould (1) having at least two mould parts (2, 3), the provision of positioning means (9, 22) for positioning the mould parts (2, 3) with respect to one another a nominal distance apart such that a mould cavity (6) is obtained, injecting a fluid material (26) into the mould cavity under pressure, influencing the positioning means (9, 22) in such a way that the nominal mutual spacing of the mould parts is maintained when injecting the material (26) into the mould cavity (6) under pressure.

The invention relates to the injection moulding of plastic articles, for example information carriers such as CDs and DVDs. With information carriers of this type a plastic disc is used which contains a structure, such as a spiral track of small pits, in which the information concerned is stored, for example for reproducing sound, image or software in general. Other structures or groupings of geometric shapes are also possible.

The quality of the track of minuscule pits is extremely important for the reliable reproduction of the stored information.

In the production of such an information carrier hot, fluid plastic is injected into a mould under high pressure. This mould usually contains a master disc containing the negative of the track in the end product. Relatively high pressures are used in order to be able to reproduce in the plastic, in the correct manner, even those parts of the track that are the greatest distance away from the injection opening of the mould.

The mould and in particular the installation in which the mould is accommodated must be able to withstand the high pressure. For this reason the mould parts from which the mould is made up are pressed onto one another under very high prestressing during injection of the plastic. This prestressing is usually supplied by powerful hydraulic piston/cylinder devices. However, the forces generated in the installation by these piston/cylinder devices under a hydraulic pressure of about 300 bar are so high that, despite the heavyweight construction of the installation, appreciable deformations still nevertheless arise.

Moreover, it is found that the high prestressing does not always meet the requirement to keep the mould parts reliably pressed onto one another when injecting the plastic under high pressure. The mould parts can nevertheless still be moved away from one another (axially) and in the transverse direction (radially) with respect to one another for a short time, which phenomenon in turn has to be compensated for in some other way. Consequently, fairly large variations in the quality of the product produced must be accepted. In the worst case it is possible that the abovementioned structure is even not obtained. This means that, despite the heavy and expensive installation that is usually used, an optimum production process cannot be achieved.

The aim of the invention is first of all to provide a method by means of which rational production is made possible and the products obtained have a more constant quality and fall within narrow tolerances. Said aim is achieved by means of a method for the injection moulding of an article, such as a CD or a DVD, comprising the following steps:

the provision of a mould having two mould parts which can be moved with respect to one another,

the provision of positioning means for positioning the mould parts with respect to one another in a nominal mutual position such that a mould cavity is obtained,

injecting a heated, fluid plastic material into the mould cavity under pressure,

influencing the positioning means in such a way that the mould cavity is maintained when injecting the plastic material into the mould cavity under pressure.

With the method according to the invention holding the mould parts clamped onto one another under a very high prestressing is dispensed with. Instead of this the mould parts are held by positioning means in a specific desired position, which yields the intended mould cavity. With this arrangement the mould parts can be in contact with one another, possibly with some prestressing. It is also conceivable to position the mould parts with some mutual play with respect to one another, in which case timely interruption of the feed must then be taken into account during injection.

Although the hot, molten plastic is injected under high pressure, for example a pressure of 200.10⁵ N/m², even with the method according to the invention, the pressure falls as the plastic flows out between the mould parts. Normal atmospheric pressure prevails at the “front” of the plastic flowing out, such that the degree of filling is readily controllable even when the mould parts are not completely closed.

In any event it must be ensured that the plane parallelism of the mould halves is maintained when carrying out the method according to the invention. This can be achieved by operating the positioning means in the desired manner. In contrast to the prior art, the plane parallelism is not achieved by physically pressing the mould halves against one another. This means that according to the invention the mould halves are aligned with respect to one another not by pressing them against one another but by positioning them with respect to one another by means of, for example, actuators, in particular screw actuators.

Since the mould parts are held accurately with respect to one another, their position with respect to one another can also be adjusted during or immediately following injection. This can be desirable, for example, in connection with compensation for shrinkage of the cooling plastic material.

The method according to the invention can in particular be used for processing plastics. These can be either thermoplastics or thermosetting plastics. Furthermore, it is possible to process not only substances having a relatively low viscosity, such as molten plastic, but also more viscous, kneadable substances, such as ceramics.

The method according to the invention can in particular be used in the production of information carriers. In this context the invention therefore also relates to the injection moulding of an information carrier for a CD or DVD, comprising the provision of a mould, one mould half of which contains a master disc containing a spiral track for forming a corresponding mirror-image track in the information carrier, as well as the step for moving the mould parts towards one another during injection of the plastic material. The mould cavity is reduced in size somewhat during this operation. The distance travelled by this latter movement can be, for example, 120 nm.

Moving the mould parts towards one another over such a very small distance is sufficient to ensure that the projections on the master disc are pressed well into the plastic material.

The master disc, which usually is made of nickel, is accommodated in the mould. The thickness dimensions of this master disc therefore also have an influence on the dimensions of the product produced therewith. Any irregularities in the dimensions of the master disc can be compensated for by the positioning means.

Furthermore, the installation can be adjusted during production should this be necessary. In this context, the method according to the invention also comprises influencing the positioning means as a function of the result of at least one thickness measurement of an article injection-moulded in a previous cycle.

With this procedure, the thickness can optionally be measured in several positions, in order to produce an article of uniform thickness.

The invention also relates to an installation for injection moulding a plastic article, for example an information carrier, such as a CD or a DVD, comprising a mould having two mould parts, positioning means in connection with the mutual positioning of the mould parts and injection means for injecting the hot, molten plastic into the mould cavity.

The method described above can be carried out with the aid of such an installation.

The positioning means preferably comprise screw actuators, each of which can be driven by its own motor. Such screw actuators offer the possibility of holding the mould parts in a reliable and stable manner against the pressure of the injected plastic material. Very fine adjustment movements can also be carried out by means of these actuators, especially if the speed is low. The drive is preferably effected by means of servomotors.

Each screw actuator can have a nut that, by means of a bearing, is supported in a block such that it can turn, which block carries one of the mould parts and in which block the mould cavity can also be located, as well as a channel for feeding hot, molten plastic. Furthermore, each screw actuator can have a screw spindle that is connected to a yoke, which yoke carries the other mould part in such a way that said other mould part can be moved towards and away from the mould part in the block by operating the screw actuators.

The block, which, for example, is made of steel, provides a stable and dimensionally stable support for the mould and the screw actuators. In combination with the absence of high internal prestressing, this yields a relatively simple, reliable construction.

In this context it is furthermore important that the block contains a cavity in which the one mould part is located and in which the other mould part can be moved by means of the screw actuators in a tightly fitting manner.

The screw spindles can each be connected to a column on which a linear bearing engages by means of which the block is supported in a movable manner.

The invention will be explained in more detail below with reference to the installation shown in the figures for carrying out the method according to the invention.

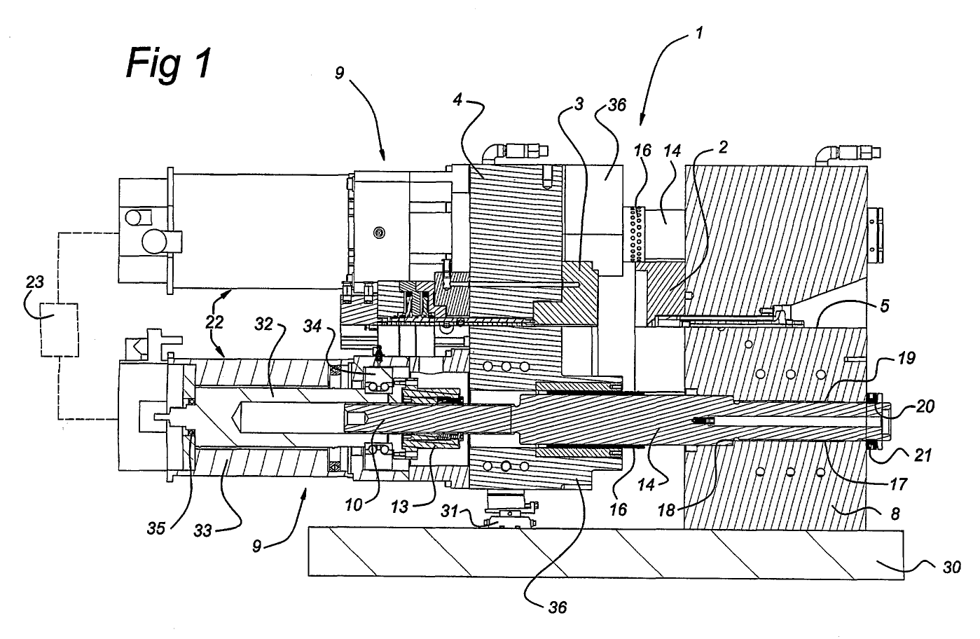

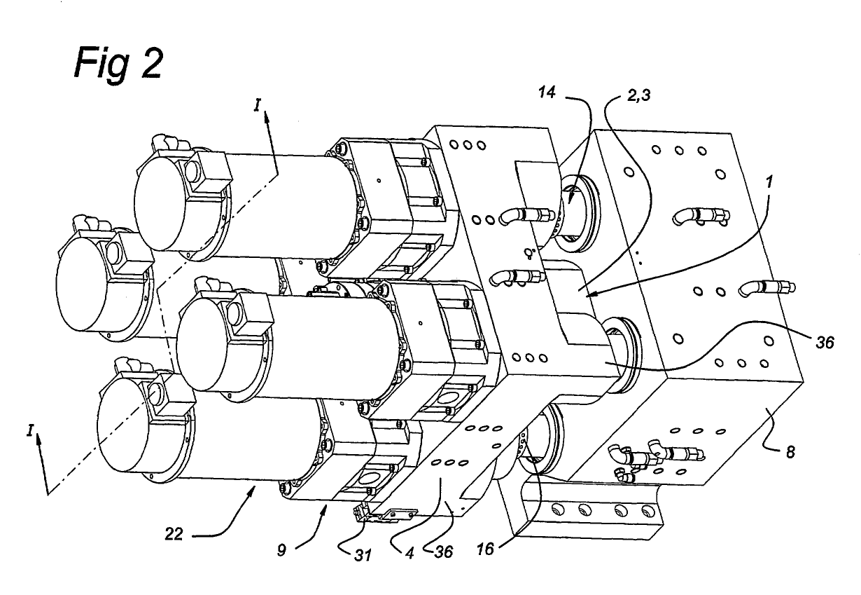

FIG. 1 shows a section through the installation in accordance with I-I in FIG. 2.

FIG. 2 shows a perspective view of the installation.

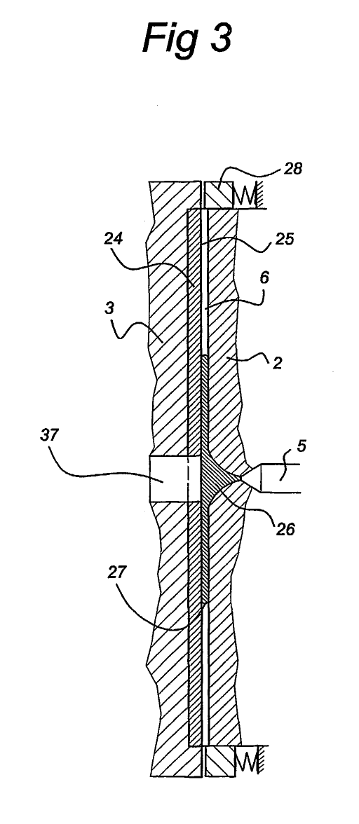

FIG. 3 shows a detail of the mould cavity when carrying out the method.

The installation according to the invention for injection moulding, for example, a CD or a DVD, which is shown in FIG. 1 and FIG. 2, contains a mould that comprises the mould parts 2 and 3 and is indicated in its entirety by 1. The mould is accommodated between the yoke 8 and the block indicated by 4. A feed channel 5 for feeding hot, molten plastic material via the mould half 2 into the mould cavity 6 between the mould parts 2, 3 (see FIG. 3) runs through the yoke 8. The air displaced during injection is able to escape by means of a resiliently compressed vent ring 28 that surrounds the mould part 2.

The mould part 2 is rigidly accommodated on the yoke 8, which, in turn, is rigidly supported on the base 30. The other mould part 3 is accommodated on the block 4 that is supported on the base 30 by means of carriages 31 such that it can be moved with respect to the yoke 8.

The ability of the block 4 to move is ensured by four screw actuators 9, two of which are shown in the section in FIG. 1.

Each screw actuator 9 has a screw spindle 10, that is fixed by means of column 14 to the yoke 8.

The columns 14 are accommodated in the bores 17 in the yoke 8 such that they fit tightly. In particular, each column 14 has a shoulder 18 that is in contact with the material of the yoke 8 around the bore 17, whilst the narrowed section 19 adjoining the shoulder 18 is provided with a threaded end 20, on which a tensioning nut 21 engages in each case. The columns 14 are thus each fixed to the yoke 8 under prestressing.

Each screw actuator 9 also has a nut 13, which by means of grooved rollers known per se interacts with the screw spindle 10 (roller screw). The nut 13 is rigidly fixed to the rotor 32 of the servomotor, which is indicated in its entirety by 22. The stator 33 thereof is fixed with respect to the block 4.

The unit consisting of nut 13 and rotor 32 is supported by means of the double row angle-contact ball bearing 34 and by the single row ball bearing 35 such that it can turn with respect to the block 4. The column 14 is also slideably supported in the block 4 by a linear ball bearing 16. The linear bearing 16 is located in a protruding collar 36 of the block 4. The advantage of this is that the bearings 16 laterally surround the mould 2, 3, as a result of which very stable support of the mould, which does not give rise to any tendency to tilt, is ensured.

On actuating the motor 22 the nut 13 is turned, with the consequence that the block 4 connected thereto via bearings 34, 35 is moved linearly with respect to the screw spindle 10, the column 14 and thus with respect to the yoke 8. During this movement the block 4 remains accurately positioned with respect to the yoke 8 by the linear ball bearings 16, which in the embodiment in question are constructed as ball bearing bushes.

The screw actuators 9 can each be controlled by means of the control device 23 in such a way that the mould parts 2 and 3 are fixed a specific distance apart. The mould parts 2, 3 are not clamped to one another in this position. By virtue of the rapid control action of the control device 23, the desired mutual spacing can, however, be maintained, despite the high pressure of the hot molten plastic material fed into the mould cavity 6 via channel 5.

The screw actuators 9 can even be operated dynamically by the control device 23 when filling the mould cavity with the plastic material in order, if necessary, to compensate for the pressure and if necessary to move the mould parts 2, 3 a little further towards one another.

This can be useful especially when producing data carriers, in which a large number of minuscule pits, cavities and the like have to be made in the plastic surface.

As shown in FIG. 3, a master disc 24 is accommodated in the mould cavity, a spiral pattern with projections being present on the surface 25 of said master disc 24 facing the mould cavity 6.

As an alternative, however, a data carrier of a different shape, for example rectangular, can also be produced. The pattern can then consist of rows of pits and the like.

When the plastic material 26 is injected via the channel 5 plastic material spreads through said mould cavity 6, as defined by the front 27.

The mould halves 2, 3 are held stable during this operation and can even be some distance apart if this is necessary in order to obtain the desired thickness of the mould cavity 6.

There are coaxial bores in the mould half 3 and the master disc 24, through which bores the pin-shaped element 37 passes with a tight fit. Said element plays a role when ejecting the finished product and when making a central hole therein.

Although four columns with screw actuators are shown in the installation shown in the figures, a different number, for example three columns with screw actuators, can also suffice.

In addition to information carriers, such as CDs and DVDs, products such as cards with an integral processor (smart cards) in plastic, encapsulated integrated circuits and optical products such as spectacle lenses can also be produced using the method and installation according to the invention. Grids, holographic optical elements (HOEs) with geometric elements smaller than the wavelength of light (nanotechnology) can also be produced in this way.

1. Method for the injection moulding of a plastic article comprising the following steps:
the provision of a mould (1) having at least two mould parts (2, 3) which can be moved with respect to one another,
injecting a heated, fluid material (26) into the mould cavity under pressure, characterized by
the provision of positioning means (9, 22) for positioning the mould parts (2, 3) with respect to one another in a nominal mutual position such that a mould cavity (6) is obtained, which nominal mutual position is adjustable during or directly after injection, and
the provision of a control device (23) influencing the position means (9, 22) by rapid control action in such a way that the desired nominal mutual position of the mould parts defining the mould cavity (6) is adjustably maintained as desired when injecting the material (26) into the mould cavity (6) under pressure or directly after injection.

2. Method according to claim 1, comprising positioning the mould parts (2, 3) some distance apart enclosing a narrow gap between them.

3. Method according to claim 1 or 2, comprising positioning the mould parts (2, 3) with respect to one another such that they are plane parallel.

4. Method according to claim 1, 2 or 3, comprising moving the mould parts (2, 3) a small distance towards one another during or following injection of the plastic material (26) into the mould cavity (6) under pressure, in order to compensate for shrinkage in the plastic material (26) during the cooling thereof.

5. Method according to claim 4, for the injection moulding of an information carrier for a CD or DVD, comprising the provision of a mould (1), one mould part (3) of which contains a master disc (24) which contains a spiral series of projections or pits in order to form a corresponding series of depressions or elevations in the information carrier, comprising the step of moving the mould parts (2, 3) towards one another, for example over a distance of approximately 120 nm.

6. Method according to claim 5, comprising influencing the positioning means (9, 22) as a function of the thickness dimensions of the master disc (24).

7. Method according to one of the preceding claims, comprising influencing the positioning means as a function of the result of at least one thickness measurement of an article injection-moulded in a previous cycle.

8. Method according to claim 7, comprising measuring the thickness of the article in several locations.

9. Installation for injection moulding of a plastic article by means of the method according to one of the preceding claims, comprising:
a mould (1) having two mould parts which can be moved with respect to one another,
injection means (5) for injecting the hot, molten plastic (26) into the mould cavity (6), characterized by
positioning means (9, 22) for positioning the mould parts (2, 3) with respect to one another in a nominal mutual position such that a mould cavity (6) is obtained, which nominal mutual position of the mould parts is adjustable during or directly after injection, and
a control device (23) for influencing the positioning means (9, 22) by rapid control action in such a way that the desired nominal mutual position of the mould parts (2, 3) defining the mould cavity (6) is adjustably maintained as desired when injecting the material (26) into the mould cavity (6) under pressure or directly after injection.

10. Installation according to claim 9, wherein the positioning means comprise screw actuators (9), each of which can be driven by means of its own motor (22).

11. Installation according to claim 10, wherein one of the mould parts (2) is fixed to a rigidly arranged yoke (8) and the other mould part (3) is fixed to a block (4) that can be moved linearly with respect to the yoke (8).

12. Installation according to claim 11, wherein each screw actuator (9) has a screw spindle that is rigidly fixed to the yoke (8) and a nut (13) that is mounted in the block (4) such that it can turn.

13. Installation according to claim 12, wherein the block (4) is supported on the column (14) by means of a linear ball bearing (16).

14. Installation according to claim 13, wherein each linear ball bearing (16) is located in a projecting collar (36) of the block (4) and the mould parts (2, 3) are located between said collars (36).

15. Installation according to one of claims 9-14, wherein one of the mould parts (2) is surrounded by a vent ring (28) that is resiliently pressed against the other mould part.

16. Installation according to one of claims 9-15, wherein each motor (22) is a servomotor.
